(19) United States
(12) Patent Application Publication
(10) Pub. No.: US 2025/0254730 A1
(43) Pub. Date: Aug. 7, 2025

(54) METHOD AND APPARATUS FOR AMBIENT POWER ENABLED IOT IN A WIRELESS COMMUNICATION SYSTEM

(71) Applicant: SAMSUNG ELECTRONICS CO., LTD., Suwon-si (KR)

(72) Inventors: Pengru LI, Beijing (CN); Feifei SUN, Beijing (CN); Qi XIONG, Beijing (CN)

(21) Appl. No.: 19/030,826

(22) Filed: Jan. 17, 2025

(30) Foreign Application Priority Data
Feb. 6, 2024 (CN) 202410172317.7

(51) Int. Cl. H04W 74/0833

(52) U.S. Cl. CPC H04W 74/0833

(57) ABSTRACT

The disclosure relates to a 5G or 6G communication system for supporting a higher data transmission rate. The present disclosure provides a communication method, a terminal, and a base station. The method comprises: acquiring configuration information related to random access, the configuration information comprising a first offset; determining resources related to random access according to the configuration information and a time domain reference point related to random access, the time domain reference point being a time domain position related to a downlink channel and/or downlink signal; and transmitting a random access signal based on the resources. The resources related to random access are determined in combination with the first offset and the time domain position related to the downlink channel and/or signal, so that the random access in an asynchronous system can be realized, and it can be applied to A-IoT and/or P-IoT or other terminal devices.

### CROSS-REFERENCE TO RELATED APPLICATION

This application is based on and claims priority under 35 U.S.C. § 119 to Chinese Patent Application No. 202410172317.7 filed on Feb. 6, 2024, in the Chinese Intellectual Property Office, the disclosure of which is incorporated by reference herein in its entirety.

### BACKGROUND

### 1. Field

The present disclosure relates to the technical field of wireless communication, and in particular to a communication method, a terminal device and a base station.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems.”

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

In some special scenarios of wireless communication systems such as Internet of things (IoT) scenarios, ambient power enabled IoT (A-IoT) devices, passive IoT (P-IoT) devices and the like are provided to realize wireless communication with lower hardware complexity and lower power consumption. However, how an A-IoT or P-IoT terminal device determines resources for random access in the wireless communication is still a problem to be solved.

### SUMMARY

An objective of the embodiments of the present disclosure is to solve the problem how an A-IoT or P-IoT terminal device determines resources for random access.

In accordance with one aspect of the embodiments of the present disclosure, a method executed by a terminal device in a communication system is provided, including:
acquiring, from a base station, configuration information related to random access, the configuration information including a first offset;
determining resources related to random access according to the configuration information and a time domain reference point related to random access, the time domain reference point being a time domain position related to a downlink channel and/or downlink signal; and
transmitting a random access signal based on the resources.

In an optional implementation, the time domain reference point includes at least one of the following:
a time domain starting position of a synchronization signal;
a time domain ending position of the synchronization signal;
a time domain starting position of a downlink signal and/or downlink channel carrying the configuration information; and
a time domain ending position of the downlink signal and/or downlink channel carrying the configuration information.

In an optional implementation, the first offset is a time domain offset between the time domain reference point and the time domain starting or ending position of a resource related to random access.

In an optional implementation, the configuration information further includes a second offset, wherein,

the second offset is a time gap between two adjacent resources related to random access in time domain; or,
the second offset is a time domain offset between a time domain starting position of an i^{th} resource related to random access and a time domain starting position of the first resource related to random access;
wherein the first resource related to random access is a resource related to random access determined based on the first offset and the time domain reference point, and the i is an integer greater than 1.

In an optional implementation, the configuration information further includes:
a number M of time domain resources related to random access.

In an optional implementation, the configuration information further includes a third offset, wherein,
the third offset is a time domain offset between a period starting position related to random access or synchronization and the time domain starting or ending position of a resource related to random access; and
the first offset is a time domain offset between the time domain reference point and the period starting position related to random access or synchronization.

In an optional implementation, the configuration information further includes a fourth offset, wherein,
the fourth offset is a time gap between two adjacent resources related to random access in time domain in a same period; or,
the fourth offset is a time domain offset between the time domain starting position of a j^{th} resource related to random access and the time domain starting position of the first resource related to random access or the period starting position of the period in the same period;
wherein the first resource related to random access is a resource related to random access determined based on the third offset and the time domain starting position of the period, and the j is an integer greater than 1.

In an optional implementation, the configuration information further includes:
a number N of time domain resources related to random access in a same period.

In an optional implementation, the resources related to random access are also determined based on a frequency domain reference point related to random access, wherein the frequency domain reference point is a frequency domain starting position corresponding to an ARFCN.

In an optional implementation, the frequency domain reference point further includes at least one of the following:
an absolute frequency point;
a frequency domain starting position of a physical resource block PRB0 f an uplink activation bandwidth part (BWP);
a frequency domain ending position of a 10^{th} PRB of a synchronization signal block (SSB);
an uplink frequency domain starting position of a channel grid operating band;
a center frequency domain position of a channel grid operating band;
a starting position of a channel grid operating band determined according to the channel grid operating band where the downlink signal and/or downlink channel is located;
a frequency domain starting position of a global synchronization channel number (GSCN);
an uplink frequency domain reference point determined according to a frequency domain starting position of a downlink signal and/or downlink channel and the frequency domain offset;
an uplink frequency domain reference point determined according to a frequency domain ending position of a downlink signal and/or downlink channel and the frequency domain offset; and
a frequency domain starting position used for uplink carrier transmission.

In an optional implementation, the configuration information further includes a fifth offset, wherein the fifth offset is a frequency domain offset between the frequency domain reference point and the frequency domain starting or ending position of a resource related to random access.

In an optional implementation, the configuration information further includes a sixth offset, wherein,
the sixth offset is a frequency domain gap between two adjacent resources related to random access in frequency domain; or,
the sixth offset is a frequency domain offset between the frequency domain starting position of a k^{th} resource related to random access and the frequency domain starting position of the first resource related to random access;
wherein the first resource related to random access is a resource related to random access determined based on the fifth offset and the frequency domain reference point, and the k is an integer greater than 1.

In an optional implementation, the configuration information further includes:
a number X of frequency domain resources related to random access.

In an optional implementation, the configuration information further includes at least one of the following:
a total number of sequences related to random access;
a length of sequences related to random access; and
indexes of sequences related to random access.

In an optional implementation, the method further includes:
generating, based on an international mobile subscriber identity (IMSI), a sequence with the sequence length related to random access.

In an optional implementation, the configuration information further includes:
information of a known terminal device;
wherein the information of the known terminal device includes at least one of the following:
an index of the terminal device;
indexes of the resource; and
a sequence index.

In an optional implementation, the indexes of the resources are obtained by numbering the first time domain resource with regard to each frequency domain resource and numbering other time domain resources successively in the same manner, wherein the indexes of the resources are numbered by skipping the resource corresponding to the frequency domain position where an uplink carrier used for reflection is located.

In an optional implementation, if the capability of the terminal device includes supporting frequency division multiplexing, the resources related to random access are mapped in an ascending order of the indexes of frequency domain resources of frequency division multiplexing and then mapped in an ascending order of the indexes of time domain resources; and/or, if the terminal device does not include the capability, the resources related to random access are mapped in an ascending order of the indexes of time domain resources.

In accordance with another aspect of the embodiments of the present disclosure, another method executed by a terminal device in a communication system is provided, including:
acquiring, from a base station, configuration information related to random access, the configuration information including a fifth offset, wherein the fifth offset is a frequency domain offset between a frequency domain reference point and the frequency domain starting or ending position of a resource related to random access, and the frequency domain reference point is a frequency domain starting position corresponding to an ARFCN;
determining resources related to random access according to the configuration information and the frequency domain reference point; and
transmitting a random access signal based on the resources.

In an optional implementation, the frequency domain reference point further includes at least one of the following:
an absolute frequency point;
a frequency domain starting position of a physical resource block PRB0 of an uplink activation bandwidth part (BWP);
the frequency domain ending position of a 10^{th} PRB of a synchronization signal block (SSB);
an uplink frequency domain starting position of a channel grid operating band;
a center frequency domain position of a channel grid operating band;
a starting position of a channel grid operating band determined according to the channel grid operating band where a downlink signal and/or downlink channel is located;
a frequency domain starting position of a global synchronization channel number (GSCN);
an uplink frequency domain reference point determined according to the frequency domain starting position of the downlink signal and/or downlink channel and the frequency domain offset;
an uplink frequency domain reference point determined according to the frequency domain ending position of the downlink signal and/or downlink channel and the frequency domain offset; and
a frequency domain starting position used for uplink carrier transmission.

In an optional implementation, the fifth offset is a frequency domain offset between the frequency domain reference point and the frequency domain starting or ending position of a resource related to random access.

In an optional implementation, the configuration information further includes a sixth offset, wherein,
the sixth offset is a frequency domain gap between two adjacent resources related to random access in frequency domain; or,
the sixth offset is a frequency domain offset between the frequency domain starting position of the k^{th} resource related to random access and the frequency domain starting position of the first resource related to random access;
wherein the first resource related to random access is a resource related to random access determined based on the fifth offset and the frequency domain reference point, and the k is an integer greater than 1.

In an optional implementation, the configuration information further includes:
a number X of frequency domain resources related to random access.

In an optional implementation, the configuration information further includes at least one of the following:
a total number of sequences related to random access;
a length of sequences related to random access; and
indexes of sequences related to random access.

In an optional implementation, the method further includes:
generating, based on an international mobile subscriber identity (IMSI), a sequence with the sequence length related to random access.

In an optional implementation, the configuration information further includes:
information of a known terminal device;
wherein the information of the known terminal device includes at least one of the following:
a terminal device index;
indexes of the resources; and
a sequence index.

In an optional implementation, the indexes of the resources are obtained by numbering the first time domain resource with regard to each frequency domain resource and numbering other time domain resources successively in the same manner, wherein the indexes of the resources are numbered by skipping the resource corresponding to the frequency domain position where an uplink carrier used for reflection is located.

In an optional implementation, if the capability of the terminal device includes supporting frequency division multiplexing, the resources related to random access are mapped in an ascending order of the indexes of frequency domain resources of frequency division multiplexing and then mapped in an ascending order of the indexes of time domain resources; and/or,

if the terminal device does not include the capability, the resources related to random access are mapped in an ascending order of the indexes of time domain resources.

In accordance with still another aspect of the embodiments of the present application, a method executed by a base station in a communication system is provided, including:
transmitting, to a terminal device, configuration information related to random access, the configuration information including a first offset; and
receiving a random access signal transmitted by the terminal device, wherein a transmit resource for the random access signal is determined based on the configuration information and a time domain reference point related to random access, and the time domain reference point is a time domain position related to a downlink channel and/or downlink signal.

In an optional implementation, the time domain reference point includes at least one of the following:
a time domain starting position of a synchronization signal;
a time domain ending position of the synchronization signal;
a time domain starting position of a downlink signal and/or downlink channel carrying the configuration information; and
a time domain ending position of the downlink signal and/or downlink channel carrying the configuration information.

In an optional implementation, the first offset is a time domain offset between the time domain reference point and the time domain starting or ending position of a resource related to random access.

In an optional implementation, the configuration information further includes a second offset, wherein,
the second offset is a time gap between two adjacent resources related to random access in time domain; or,
the second offset is a time domain offset between the time domain starting position of the i^{th} resource related to random access and the time domain starting position of the first resource related to random access;
wherein the first resource related to random access is a resource related to random access determined based on the first offset and the time domain reference point, and the i is an integer greater than 1.

In an optional implementation, the configuration information further includes:
a number M of time domain resources related to random access.

In an optional implementation, the configuration information further includes a third offset, wherein,
the third offset is a time domain offset between a period starting position related to random access or synchronization and the time domain starting or ending position of a resource related to random access; and
the first offset is a time domain offset between the time domain reference point and the period starting position related to random access or synchronization.

In an optional implementation, the configuration information further includes a fourth offset, wherein,
the fourth offset is a time gap between two adjacent resources related to random access in time domain in a same period; or,
the fourth offset is a time domain offset between the time domain starting position of the j^{th} resource related to random access and the time domain starting position of the first resource related to random access or the period starting position of the period in the same period;
wherein the first resource related to random access is a resource related to random access determined based on the third offset and the time domain starting position of the period, and the j is an integer greater than 1.

In an optional implementation, the configuration information further includes:
a number N of time domain resources related to random access in a same period.

In an optional implementation, the resources related to random access are also determined based on a frequency domain reference point related to random access, wherein the frequency domain reference point is a frequency domain starting position corresponding to an ARFCN.

In an optional implementation, the frequency domain reference point further includes at least one of the following:
an absolute frequency point;
a frequency domain starting position of a physical resource block PRB0 of an uplink activation bandwidth part (BWP);
a frequency domain ending position of a 10^{th} PRB of a synchronization signal block (SSB);
an uplink frequency domain starting position of a channel grid operating band;
a center frequency domain position of a channel grid operating band;
a starting position of a channel grid operating band determined according to the channel grid operating band where a downlink signal and/or downlink channel is located;
a frequency domain starting position of a global synchronization channel number (GSCN);
an uplink frequency domain reference point determined according to the frequency domain starting position of the downlink signal and/or downlink channel and the frequency domain offset;
an uplink frequency domain reference point determined according to the frequency domain ending position of the downlink signal and/or downlink channel and the frequency domain offset; and
a frequency domain starting position used for uplink carrier transmission.

In an optional implementation, the configuration information further includes a fifth offset, wherein the fifth offset is a frequency domain offset between the frequency domain reference point and the frequency domain starting or ending position of a resource related to random access.

In an optional implementation, the configuration information further includes a sixth offset, wherein,
the sixth offset is a frequency domain gap between two adjacent resources related to random access in frequency domain; or,
the sixth offset is a frequency domain offset between the time domain starting position of the k^{th} resource related to random access and the frequency domain starting position of the first resource related to random access;
wherein the first resource related to random access is a resource related to random access determined based on the fifth offset and the frequency domain reference point, and the k is an integer greater than 1.

In an optional implementation, the configuration information further includes:
a number X of frequency domain resources related to random access.

In an optional implementation, the configuration information further includes at least one of the following:
a total number of sequences related to random access;
a length of sequences related to random access; and
indexes of sequences related to random access.

In an optional implementation, a sequence with the sequence length related to random access is generated by the terminal device based on an international mobile subscriber identity (IMSI).

In an optional implementation, the configuration information further includes:
information of a known terminal device;
wherein the information of the known terminal device includes at least one of the following:
a terminal device index;
indexes of the resources; and
a sequence index.

In an optional implementation, the indexes of the resources are obtained by numbering the first time domain resource with regard to each frequency domain resource and numbering other time domain resources successively in the same manner, wherein the indexes of the resources are numbered by skipping the resource corresponding to the frequency domain position where an uplink carrier used for reflection is located.

In an optional implementation, if the capability of the terminal device includes supporting frequency division multiplexing, the resources related to random access are mapped in an ascending order of the indexes of frequency domain resources of frequency division multiplexing and then mapped in an ascending order of the indexes of time domain resources; and/or,
if the terminal device does not include the capability, the resources related to random access are mapped in an ascending order of the indexes of time domain resources.

In accordance with yet another aspect of the embodiments of the present application, a method executed by a base station in a communication system is provided, including:
transmitting, to a terminal device, configuration information related to random access, the configuration information including a fifth offset, wherein the fifth offset is a frequency domain offset between a frequency domain reference point and the frequency domain starting or ending position of a resource related to random access, and the frequency domain reference point is a frequency domain starting position corresponding to an ARFCN;
receiving a random access signal transmitted by the terminal device, wherein a transmit resource for the random access signal is determined based on the configuration information and the frequency domain reference point.

In an optional implementation, the frequency domain reference point further includes at least one of the following:
an absolute frequency point;
a frequency domain starting position of a physical resource block PRB0 of an uplink activation bandwidth part (BWP);
a frequency domain ending position of the 10^{th} PRB of a synchronization signal block (SSB);
an uplink frequency domain starting position of a channel grid operating band;
a center frequency domain position of a channel grid operating band;
a starting position of a channel grid operating band determined according to the channel grid operating band where a downlink signal and/or downlink channel is located;
a frequency domain starting position of a global synchronization channel number (GSCN);
an uplink frequency domain reference point determined according to the frequency domain starting position of the downlink signal and/or downlink channel and the frequency domain offset;
an uplink frequency domain reference point determined according to the frequency domain ending position of the downlink signal and/or downlink channel and the frequency domain offset; and
a frequency domain starting position used for uplink carrier transmission.

In an optional implementation, the fifth offset is a frequency domain offset between the frequency domain reference point and the frequency domain starting or ending position of a resource related to random access.

In an optional implementation, the configuration information further includes a sixth offset, wherein,
the sixth offset is a frequency domain gap between two adjacent resources related to random access in frequency domain; or,
the sixth offset is a frequency domain offset between the frequency domain starting position of the k^{th} resource related to random access and the frequency domain starting position of the first resource related to random access;
wherein the first resource related to random access is a resource related to random access determined based on the fifth offset and the frequency domain reference point, and the k is an integer greater than 1.

In an optional implementation, the configuration information further includes:
a number X of frequency domain resources related to random access.

In an optional implementation, the configuration information further includes at least one of the following:
a total number of sequences related to random access;
a length of sequences related to random access; and
indexes of sequences related to random access.

In an optional implementation, a sequence with the sequence length related to random access is generated by the terminal device based on an international mobile subscriber identity (IMSI).

In an optional implementation, the configuration information further includes:
information of a known terminal device;
wherein the information of the known terminal device includes at least one of the following:
a terminal device index;
indexes of the resources; and
a sequence index.

In an optional implementation, the indexes of the resources are obtained by numbering the first time domain resource with regard to each frequency domain resource and numbering other time domain resources successively in the same manner, wherein the indexes of the resources are numbered by skipping the resource corresponding to the frequency domain position where an uplink carrier used for reflection is located.

In an optional implementation, if the capability of the terminal device includes supporting frequency division multiplexing, the resources related to random access are mapped in an ascending order of the indexes of frequency domain resources of frequency division multiplexing and then mapped in an ascending order of the indexes of time domain resources; and/or,
if the terminal device does not include the capability, the resources related to random access are mapped in an ascending order of the indexes of time domain resources.

In accordance with yet another aspect of the embodiments of the present disclosure, a terminal device is provided, including: a transceiver and a processor, wherein the processor is coupled to the transceiver and configured to execute the method executed by a terminal device in a communication system according to the embodiments of the present disclosure.

In accordance with yet another aspect of the embodiments of the present disclosure, a base station is provided, including: a transceiver and a processor, wherein the processor is coupled to the transceiver and configured to execute the method executed by a base station in a communication system according to the embodiments of the present disclosure.

In accordance with yet another aspect of the embodiments of the present disclosure, a computer-readable storage medium is provided, having computer programs stored thereon that, when executed by a processor, implement the method executed by a terminal device in a communication system according to the embodiments of the present disclosure.

In accordance with yet another aspect of the embodiments of the present disclosure, a computer-readable storage medium is provided, having computer programs stored thereon that, when executed by a processor, implement the method executed by a base station in a communication system according to the embodiments of the present disclosure.

In accordance with yet another aspect of the embodiments of the present disclosure, a computer program product is provided, including computer programs that, when executed by a processor, implement the method executed by a terminal device in a communication system according to the embodiments of the present disclosure.

In accordance with yet another aspect of the embodiments of the present disclosure, a computer program product is provided, including computer programs that, when executed by a processor, implement the method executed by a base station in a communication system according to the embodiments of the present disclosure.

In the communication method, the terminal device and the base station provided in the embodiments of the present disclosure, configuration information related to random access is acquired from a base station, the configuration information including a first offset; resources related to random access are determined according to the configuration information and a time domain reference point related to random access, the time domain reference point being a time domain position related to a downlink channel and/or downlink signal; and, a random access signal is transmitted based on the resources. In other words, in the embodiments of the present disclosure, the resources related to random access are determined in combination with the first offset and the time domain position related to the downlink channel and/or downlink signal, so that the random access in an asynchronous system can be realized, and it can be applied to A-IoT and/or P-IoT or other terminal devices.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

To describe the technical schemes in the embodiments of the present disclosure more clearly, the drawings to be used in the description of the embodiments of the present disclosure will be briefly introduced below.

FIG. 1 illustrates an overall structure of a wireless network according to an embodiment of the present disclosure;

FIG. 2A illustrates a transmission path according to an embodiment of the present disclosure;

FIG. 2B illustrates a reception path according to an embodiment of the present disclosure;

FIG. 3A illustrates a UE according to an embodiment of the present disclosure;

FIG. 3B illustrates a base station according to an embodiment of the present disclosure;

FIG. 4 illustrates a method executed by a terminal device in a communication system according to an embodiment of the present disclosure;

FIG. 5 illustrates an example for determining a random access time domain resource based on a downlink signal and/or downlink channel according to an embodiment of the present disclosure;

FIG. 6 illustrates an example for determining a group of random access time domain resources based on a downlink signal and/or downlink channel according to an embodiment of the present disclosure;

FIG. 7 illustrates an example for determining a group of periodic random access time domain resources based on a downlink signal and/or downlink channel according to an embodiment of the present disclosure;

FIG. 8 illustrates an example for determining multiple groups of periodic random access time domain resources based on a downlink signal and/or downlink channel according to an embodiment of the present disclosure;

FIG. 9 illustrates information of a known terminal device according to an embodiment of the present disclosure;

FIG. 10 illustrates information of another known terminal device according to an embodiment of the present disclosure;

FIG. 11 illustrates another method performed by a terminal device in a communication system according to an embodiment of the present disclosure;

FIG. 12 illustrates a method performed by a base station in a communication system according to an embodiment of the present disclosure;

FIG. 13 illustrates another method performed by a base station in a communication system according to an embodiment of the present disclosure;

FIG. 14 illustrates an electronic device according to an embodiment of the present disclosure;

FIG. 15 illustrates a structure of a UE according to an embodiment of the present disclosure; and

FIG. 16 illustrates a structure of a base station according to an embodiment of the present disclosure.

### DETAILED DESCRIPTION

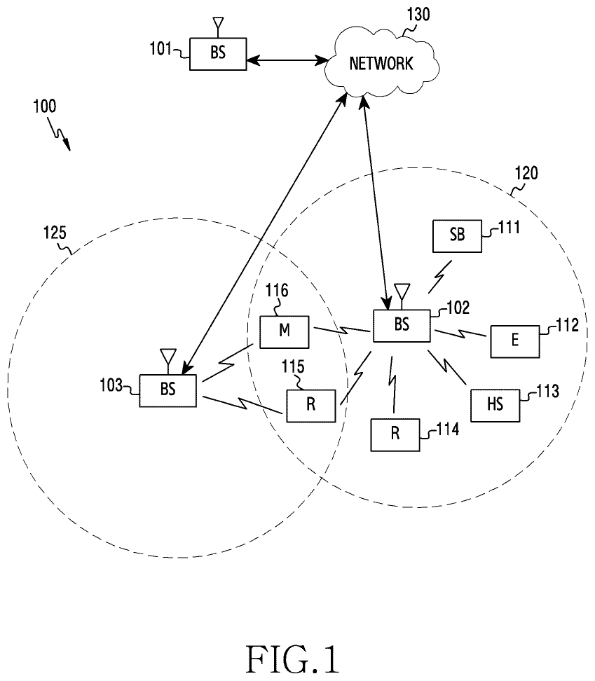

FIGURES. 1 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. The gNB 101 communicates with the gNB 102 and the gNB 103. The gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB.” For convenience, the terms “gNodeB” and “gNB” are used in this patent document to refer to network infrastructure components that provide wireless access for remote terminals. And, depending on the type of the network, other well-known terms such as “mobile station,” “user station,” “remote terminal,” “wireless terminal” or “user apparatus” can be used instead of “user equipment” or “UE.” For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. The gNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, the gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, the gNB 101, 102 and/or 103 can provide access to other or additional external networks, such as external telephone networks or other types of data networks.

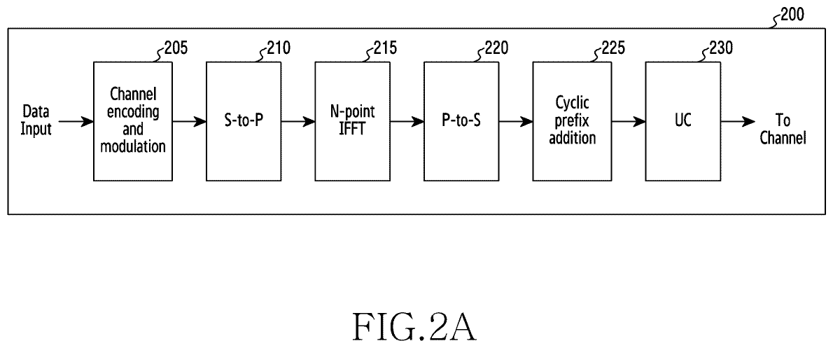

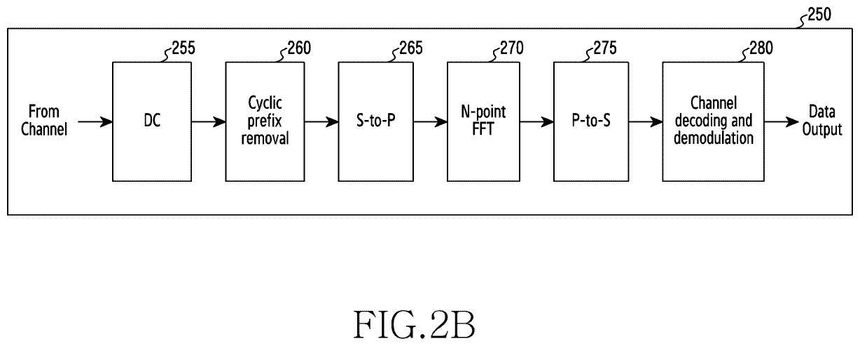

FIGS. 2A and 2B illustrate examples of wireless transmission and reception paths according to the present disclosure. In the following description, the transmission path 200 can be described as being implemented in a gNB, such as the gNB 102, and the reception path 250 can be described as being implemented in a UE, such as the UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N inverse fast Fourier transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N fast Fourier transform (FFT) block 270, a Parallel-to-Serial (P-to-S) block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The serial-to-parallel (S-to-P) block 210 converts (such as demultiplexes) serial modulated symbols into parallel data to generate N parallel symbol streams, where N is a size of the IFFT/FFT used in the gNB 102 and the UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from the gNB 102 arrives at the UE 116 after passing through the wireless channel, and operations in reverse to those at the gNB 102 are performed at the UE 116. The down-converter 255 down-converts the received signal to a baseband frequency, and the cyclic prefix removal block 260 removes the cyclic prefix to generate a serial time-domain baseband signal. The serial-to-parallel block 265 converts the time-domain baseband signal into a parallel time-domain signal. The size N FFT block 270 performs an FFT algorithm to generate N parallel frequency-domain signals. The parallel-to-serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

FIG. 2A illustrates a transmission path according to an embodiment of the present disclosure, and FIG. 2B illustrates a reception path according to an embodiment of the present disclosure.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as discrete Fourier transform (DFT) and inverse discrete Fourier transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

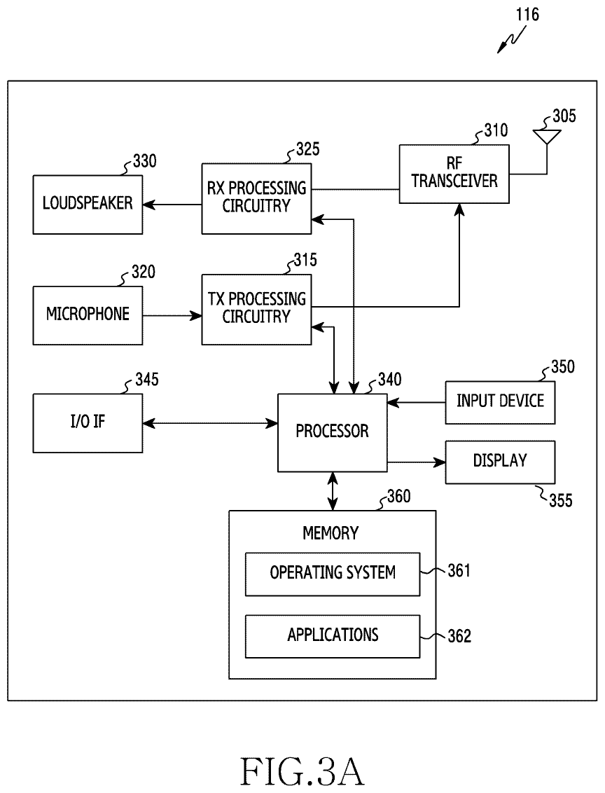

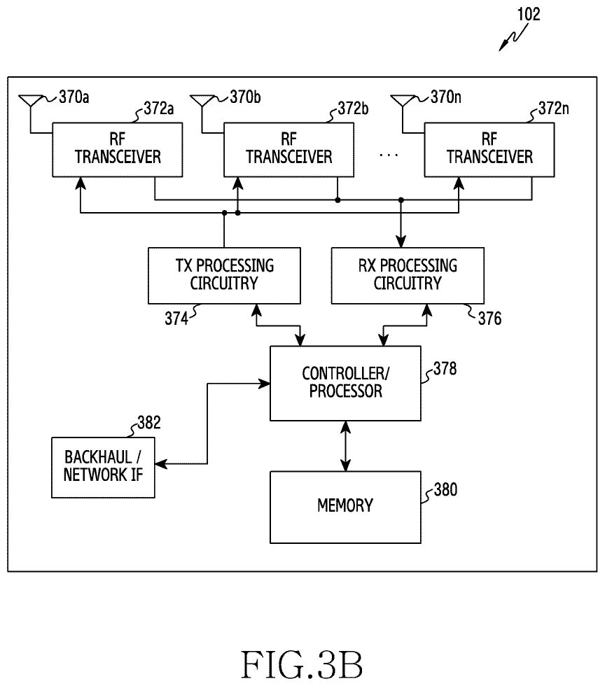

FIG. 3A illustrates an example of UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 301, a radio frequency (RF) transceiver 302, a transmission (TX) processing circuit 303, a microphone 304, and a reception (RX) processing circuit 305. A UE 116 also includes a speaker 306, a controller/processor 307, an input/output (I/O) interface 308, an input device(s) 309, a display 310, and a memory 311. The memory 311 includes an operating system (OS) 312 and one or more applications 313.

The RF transceiver 302 receives an incoming RF signal transmitted by a gNB of the wireless network 100 from the antenna 301. The RF transceiver 302 down-converts the incoming RF signal to generate an intermediate frequency (IF) or baseband signal. The IF or baseband signal is transmitted to the RX processing circuit 305, where the RX processing circuit 305 generates a processed baseband signal by filtering, decoding and/or digitizing the baseband or IF signal. The RX processing circuit 305 transmits the processed baseband signal to speaker 306 (such as for voice data) or to controller/processor 307 for further processing (such as for web browsing data).

The TX processing circuit 303 receives analog or digital voice data from microphone 304 or other outgoing baseband data (such as network data, email or interactive video game data) from controller/processor 307. The TX processing circuit 303 encodes, multiplexes, and/or digitizes the outgoing baseband data to generate a processed baseband or IF signal. The RF transceiver 302 receives the outgoing processed baseband or IF signal from the TX processing circuit 303 and up-converts the baseband or IF signal into an RF signal transmitted via the antenna 301.

The controller/processor 307 can include one or more processors or other processing devices and execute an OS 312 stored in the memory 311 in order to control the overall operation of the UE 116. For example, the controller/processor 307 can control the reception of forward channel signals and the transmission of backward channel signals through the RF transceiver 302, the RX processing circuit 305 and the TX processing circuit 303 according to well-known principles. In some embodiments, the controller/processor 307 includes at least one microprocessor or microcontroller.

The controller/processor 307 is also capable of executing other processes and programs residing in the memory 311, such as operations for channel quality measurement and reporting for systems with 2D antenna arrays as described in embodiments of the present disclosure. The controller/processor 307 can move data into or out of the memory 311 as required by an execution process. In some embodiments, the controller/processor 307 is configured to execute the application 313 based on the OS 312 or in response to signals received from the gNB or the operator. The controller/processor 307 is also coupled to an I/O interface 308, where the I/O interface 308 provides the UE 116 with the ability to connect to other devices such as laptop computers and handheld computers. I/O interface 308 is a communication path between these accessories and the controller/processor 307.

The controller/processor 307 is also coupled to the input device(s) 309 and the display 310. An operator of the UE 116 can input data into the UE 116 using the input device(s) 309. The display 310 may be a liquid crystal display or other display capable of presenting text and/or at least limited graphics (such as from a website). The memory 311 is coupled to the controller/processor 307. A part of the memory 311 can include a random access memory (RAM), while another part of the memory 311 can include a flash memory or other read-only memory (ROM).

Although FIG. 3A illustrates an example of a UE 116, various changes can be made to FIG. 3A. For example, various components in FIG. 3A can be combined, further subdivided or omitted, and additional components can be added according to specific requirements. As a specific example, the controller/processor 307 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that the gNB 101 and the gNB 103 can include the same or similar structures as the gNB 102.

As shown in FIG. 3B, the gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. The gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in the gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows the gNB 102 to communicate with other devices or systems through a backhaul connection or through a network. The backhaul or network interface 382 can support communication over any suitable wired or wireless connection(s). For example, when the gNB 102 is implemented as a part of a cellular communication system, such as a cellular communication system supporting 5G or new radio access technology or NR, LTE or LTE-A, the backhaul or network interface 382 can allow the gNB 102 to communicate with other gNBs through wired or wireless backhaul connections. When the gNB 102 is implemented as an access point, the backhaul or network interface 382 can allow the gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, the gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, the gNB 102 can include multiple instances of each (such as one for each RF transceiver). To make the objectives, technical schemes and advantages of the present disclosure clearer, the implementations of the present disclosure will be further described below in detail with reference to the drawings.

To make the objectives, technical schemes and advantages of the present disclosure clearer, the implementations of the present disclosure will be further described below in detail with reference to the drawings.

The embodiments of the present disclosure provide a communication method, a terminal device and a base station, specifically a method and device for random access resource configuration, including but not limited to a method for determining time domain resources related to random access, a method for determining frequency domain resources related to random access, a method for determining a generated sequence related to random access or the like.

The technical schemes in the embodiments of the present disclosure can be applied to various communication systems, such as global system for mobile communications (GSM) systems, code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunication systems (UMTSs), worldwide interoperability for microwave access (WiMAX) communication systems, 5^{th} generation (5G) systems or new radio (NR) systems. In addition, the technical schemes in the embodiments of the present disclosure can be applied to future-oriented communication technologies.

The technical schemes in the embodiments of the present disclosure and the technical effects achieved by the technical schemes of the present disclosure will be explained below by describing several exemplary implementations. It should be pointed out that the following implementations can be referred to, learned from or combined with each other, and the same terms, similar features and similar implementation steps in different implementations will not be repeated.

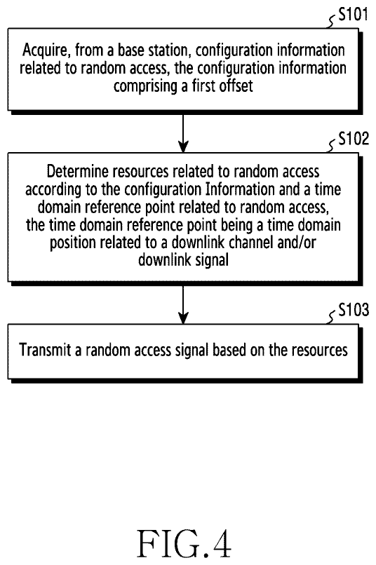

FIG. 4 illustrates a method executed by a terminal device in a communication system according to an embodiment of the present disclosure.

In an embodiment of the present disclosure, a method executed by a terminal device in a communication system is provided. As shown in FIG. 4, this method includes the following steps.

In step S101, configuration information related to random access is acquired from a base station, the configuration information including a first offset.

In step S102, resources related to random access are determined according to the configuration information and a time domain reference point related to random access, the time domain reference point being a time domain position related to a downlink channel and/or downlink signal.

In step S103, a random access signal is transmitted based on the resources.

In the embodiment of the present disclosure, the configuration information, time domain reference point, resource and the like related to random access can also be interpreted as the configuration information, time domain reference point, resource and the like used for random access. Hereinafter, for the convenience of description, “related to random access” may also be described as “used for random access,” and both can be interchanged.

The transmission link of the wireless communication system mainly includes: a downlink communication link from a gNB (base station) to a user equipment (UE) in the 5G new radio or 6G or future wireless communication scenario, an uplink communication link from a UE to a network, and a side communication link (sidelink (SL) from a UE to a UE, which may also be called a bypass communication link or the like. Terminal devices such as A-IoT or P-IoT (which may also be referred to as A-IoT or P-IoT tags) may establish an uplink communication link in an active transmission manner, or may establish an uplink communication link by reflecting an uplink carrier. At this time, how to determine time domain resources used for random access is a problem to be solved.

In the embodiment of the present disclosure, the downlink signal and/or channel is used as a signal for triggering the terminal device to execute a random access process, that is, the time domain position related to the downlink channel and/or downlink signal is used as a time domain reference point; and, time domain resources used for random access are determined in combination with the first offset, so that the random access in an asynchronous system can be realized.

Optionally, the method executed by a terminal device in a communication system provided in the embodiment of the present disclosure can be applied to special scenarios for example, terminal devices such as A-IoT and/or P-IoT. The devices such as A-IoT and/or P-IoT can further reduce the energy loss of the terminal side, and also reduce the deployment cost of devices. Specifically, an A-IoT or P-IoT terminal device may receive a radio frequency (RF) signal (which is a radio signal) and/or collect solar energy, vibration, heat energy, wind energy or other energy sources and convert the received energy into AC or DC voltage, for example, converting the RF signal into a DC signal through an RF-DC converter and then transmitting the electric energy to a rechargeable battery, a capacitor or other electric energy storage device for establishing a wireless communication link.

It should be understood that, using the downlink channel and/or downlink signal as the signal for triggering the terminal device to execute the random access process in the A-IoT and/or P-IoT scenario is a non-limiting example, the exemplary method is described in this example in the embodiment of the present disclosure, and the described method can also be used to receive other signals and/or channels in IoT or other scenarios.

In the embodiment of the present disclosure, the terminal device acquires configuration information related to random access by receiving a downlink signal and/or downlink channel. The downlink signal and/or downlink channel may explicitly indicate the configuration information related to random access through bit information, and the configuration method for the downlink signal and/or downlink channel may include a combination of one or more of the following.
(1) The downlink signal and/or downlink channel may be a signal or channel periodically broadcast in the cell, and is used to trigger the terminal device to execute the random access process to inventory all terminal devices which can be inventoried within the coverage range of the cell; or, the downlink signal and/or downlink channel may be a signal or channel periodically multicast in the cell, and is used to schedule one terminal device or a group of terminal devices in the cell. The downlink signal and/or downlink channel may be configured through a radio resource control (RRC) message, and the terminal device acquires the configuration information related to random access by receiving the periodically transmitted downlink signal and/or downlink channel. Optionally, when the period of the downlink signal and/or downlink channel is not configured, the UE may default the period of the downlink signal and/or downlink channel as a predefined value, e.g., 20 ms.
(2) The downlink signal and/or downlink channel may be configured semi-statically, and the terminal device activates and/or deactivates the resource of the downlink signal and/or downlink channel used for triggering the terminal device to execute the random access process by receiving an RRC message and/or a medium access control (MAC) control element (CE) message. The terminal device receives the downlink signal and/or downlink channel on the activated resource, and acquires the configuration information related to random access.
(3) The downlink signal and/or downlink channel may be configured dynamically. The resource of the downlink signal and/or downlink channel used for triggering the terminal device to execute the random access process may be dynamically indicated through downlink control information (DCI). Optionally, the terminal device determines the resource of the downlink signal and/or downlink channel by receiving a newly defined DCI format. The information carried by the newly defined DCI format includes at least one of the following: a time domain resource assignment (TDRA) for determining the time domain resource position of the downlink signal and/or downlink channel, and a frequency domain resource assignment (FDRA) for determining the frequency domain resource position of the downlink signal and/or downlink channel.

In the embodiment of the present disclosure, the time domain reference point may include, but not limited to, at least one of the following:
(1) a time domain starting position of a synchronization signal;
(2) a time domain ending position of the synchronization signal;
wherein, the time domain starting position may also be referred to as the time domain starting point position or the time domain starting point or the starting point, and the time domain ending position may also be referred to as the time domain ending point position or the time domain ending point. Optionally, the time domain starting position or time domain ending position of the synchronization signal closest to the downlink signal and/or downlink channel is used as the time domain reference point, and the time domain starting position of the random access resource is the time domain reference point plus a predefined or preconfigured time gap (first offset). Optionally, the time gap may be determined based on the downlink signal and/or downlink channel;
(3) a time domain starting position of the downlink signal and/or downlink channel carrying the configuration information;
(4) a time domain ending position of the downlink signal and/or downlink channel carrying the configuration information,
optionally, starting from the time domain starting position or time domain ending position of the downlink signal and/or downlink channel, the position after a predefined or preconfigured time gap (first offset) is determined as the time domain starting position of the random access resource. Optionally, the time gap may be determined based on the downlink signal and/or downlink channel; and/or
(5) a predetermined time unit, e.g., a radio system frame number 0 slot 0 (SFN0slot0). Considering the SFN0slot0 is an absolute time domain starting position, the terminal device provided in the embodiment of the present disclosure and the UE of NR can share the same time domain starting position. The terminal device determines the index of the SNF where the downlink signal and/or downlink channel is located by receiving the downlink signal and/or downlink channel. Optionally, the terminal device may determine the time domain starting position of the random access resource through the indicated index of the SFN and a predefined or preconfigured time gap (first offset). Optionally, the time gap may be determined based on the downlink signal and/or downlink channel.

In the embodiment of the present disclosure, the configuration information related to random access may include, but not limited to, a combination of one or more of the following:
(1) The time domain resource period related to random access. The time domain starting position of the period may be counted from the SFN where the downlink signal and/or downlink channel is located, or the time domain starting position of the period may be counted from the time domain starting position or time domain ending position of the downlink signal and/or downlink channel plus a predefined or preconfigured time domain offset (first offset). Wherein, the predefined or preconfigured time domain offset is a real number greater than or equal to 0. This configuration is more suitable for configuring a group of periodic time domain resources, so that it is convenient to align the time granularity with other signals or channels. A plurality of configured access occasions can enable the UE to transmit a sequence used for random access on the periodic time domain resources used for random access at different transmission powers under the limitation of the maximum number of transmissions of the sequence used for random access.
(2) The time domain starting position or time domain ending position of the first time domain resource used for random access in a period of time-domain resources used for random resources. Optionally, the time domain starting position or time domain ending position of the first time domain resource used for random access may be preconfigured, or determined by the time domain starting position of the time domain resource period used for random access and a predefined or preconfigured time domain offset (third offset), wherein the predefined or preconfigured time domain offset is a real number greater than or equal to 0.
(3) The number N of time domain resources related to random access in a same period, i.e., the number N of time domain resources used for random access in a period of time domain resources used for random access, where N is a real number greater than 1.
(4) The time domain offset of N−1 time domain starting positions or time domain ending positions in a period of time domain resources used for random access relative to the time domain starting position or time domain ending position of the first time domain resource used for random access or the time gap between two adjacent time domain resources used for random access. The time gap between two adjacent time domain resources used for random access in a period is the time gap from the time domain ending position of the previous time domain resource used for random access to the time domain starting position of the next time domain resource used for random access. This configuration parameter is used to indicate a time domain starting positions of N−1 time domain resources used for random access in a period of time domain resources used for random access. Optionally, the time gap between two adjacent time domain resources used for random access in a period may be a predefined or preconfigured real number, or may be N−1 predefined values.
(5) The duration of a time domain resources used for random access. It indicates the duration of a time domain resource starting from the time domain starting position of the time domain resource used for random access.
(6) The number M of time domain resources related to random access, i.e., the number M of time domain resources used for random access starting from the reception of the downlink signal and/or downlink channel, where M is a real number greater than 1.
(7) The time domain starting position or time domain ending position of the first time domain resource used for random access starting from the reception of the downlink signal and/or downlink channel. The time domain starting position or time domain ending position of the first time domain resource used for random access may be determined by the time domain reference point of the random access resource and a predefined or preconfigured time domain offset (first offset), wherein the predefined or preconfigured time domain offset is a real number greater than or equal to 0.
(8) M−1 time gaps from the time domain reference point of the random access resource or the time domain starting position of the first time domain resource used for random access to the time domain starting positions of M−1 time domain resources used for random access, and/or the time gap between two adjacent time domain resources used for random access. This configuration parameter is used to indicate M time domain resources used for random access. Optionally, the time gap between two adjacent time domain resources used for random access is the time gap from the time domain ending position of the previous time domain resource used for random access to the time domain starting position of the next time domain resource used for random access, and may be a predefined or preconfigured time domain offset (second offset) or may be M−1 predefined or preconfigured time domain offsets. This configuration is suitable for configuring a group of aperiodic time domain resources. The time domain offset is to reduce the influence from the time domain synchronization error.
(9) The format of the sequence used for random access, including the length of the guard gap for reducing the uplink synchronization error and/or the length of the sequence used for random access and/or the length of the guard gap for reducing the collision caused by the synchronization error between terminal devices.
(10) The maximum number of transmissions of the sequence used for random access. Considering that the terminal device does not know the transmit power of the sequence when transmitting the random access sequence, at this time, the terminal device may determine the transmit power of one sequence and then transmit the sequence used for random access on the resource used for random access by using the transmit power. If no random access response is received after a predefined or preconfigured period of time, the terminal device may increase the transmit power and transmit the reselected sequence used for random access on the resource used for random access. The maximum number of transmissions is set to limit the number of retransmissions of the random access sequence by the terminal device. This configuration mode is more suitable for configuring periodic resources used for random access.

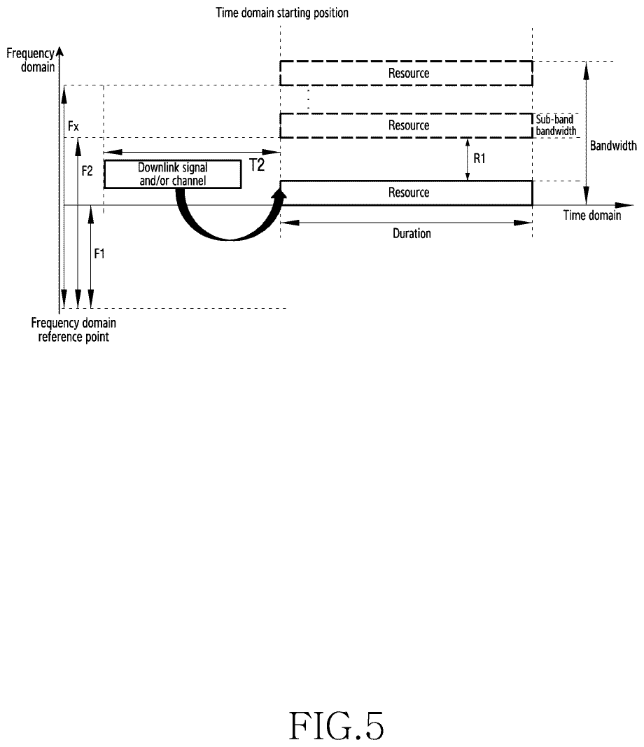

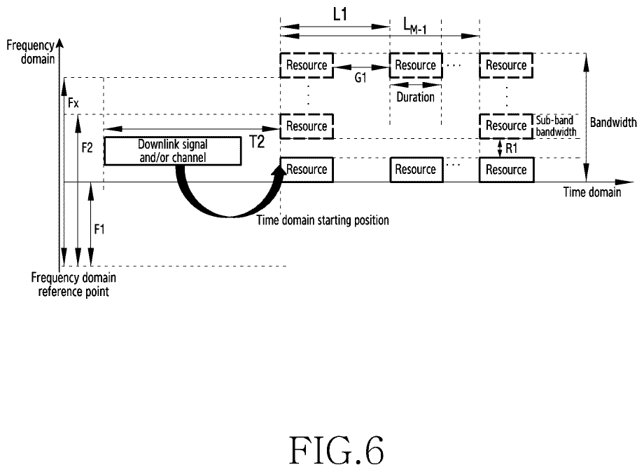

FIG. 5 illustrates an example for determining a random access time domain resource based on a downlink signal and/or downlink channel according to an embodiment of the present disclosure, and FIG. 6 illustrates an example for determining a group of random access time domain resources based on a downlink signal and/or downlink channel according to an embodiment of the present disclosure.

In an optional implementation, the first offset is a time domain offset between the time domain reference point and the time domain starting or ending position of a resource related to random access. As an example, the terminal device may determine the time domain starting position of a time domain resource used for random access by using the time domain reference point of the random access resource and the first offset (e.g., time gap T2) determined based on the downlink signal and/or downlink channel, or the time domain starting position of the time domain resource used for random access is not earlier than the time domain reference point of the random access resource plus a predefined or preconfigured time gap. The duration of a time domain resource used for random access is determined by receiving the downlink signal and/or downlink channel, as shown in FIG. 5. The time gap T2 is the time gap from the time domain reference point of the random access resource to the time domain starting position where the time domain resource used for random access is located. Wherein, the content on the frequency domain in FIG. 5 can refer to the following description.

Optionally, the configuration information further includes a second offset, wherein the second offset is the time domain offset between the time domain starting position of the i^{th} resource related to random access and the time domain starting position of the first resource related to random access, where the first resource related to random access is a resource related to random access determined based on the first offset and the time domain reference point, and the i is an integer greater than 1. That is, the terminal device may determine the time domain starting position of the first time domain resource used for random access by using the time domain reference point of the random access resource and the first offset (e.g., time gap T2) determined based on the downlink signal and/or downlink channel. Or the time domain starting position of the first time domain resource used for random access is not earlier than the time domain reference point of the random access resource plus a predefined or preconfigured time gap. Based on a group of time gaps {L1, . . . , L_{M-1}} (i.e., second offsets) from the time domain reference point of the random access resource or the time domain starting position of the first time domain resource used for random access to a group of time domain starting positions of the time domain resources used for random access, a group of time domain starting positions of the time domain resources used for random access is determined; or, the time domain starting positions of subsequent M−1 time domain resources are not earlier than the time domain reference point of the random access resource or the time domain starting position of the first time domain resource used for random access plus a group of M−1 predefined or preconfigured time gaps. The duration of a time domain resource used for random access is determined by receiving the downlink signal and/or downlink channel, as shown in FIG. 6. L₁, . . . ,L_{M-1} are predefined or preconfigured values, and L₁, . . . , L_{M-1} are real numbers greater than or equal to 0.

Or the second offset is a time gap between two adjacent resources related to random access in time domain. Wherein the first resource related to random access is a resource related to random access determined based on the first offset and the time domain reference point. That is, the terminal device may determine the time domain starting position of the first time domain resource used for random access by using the time domain reference point of the random access resource and the first offset (e.g., time gap T2) determined based on the downlink signal and/or downlink channel. Or the time domain starting position of the first time domain resource used for random access is not earlier than the time domain reference point of the random access resource plus a predefined or preconfigured time gap. The time domain starting positions of subsequent M−1 time domain resources are determined according to the time domain starting or ending position of the first time domain resource used for random access and/or the time gap G1 (i.e., second offset) between two adjacent time domain resources used for random access configured based on the downlink signal and/or downlink channel and the number M of time domain resources used for random access from the reception of the downlink signal and/or downlink channel, as shown in FIG. 6. Wherein, G1 is a predefined or preconfigured value, and G1 is a real number greater than or equal to 0. When the format of the sequence used for random access is configured, G1=0. Wherein, the content on the frequency domain in FIG. 6 can refer to the following description. Or the time domain starting positions of subsequent M−1 time domain resources are not earlier than the time domain starting or ending position of the previous time domain resource used for random access plus a predefined or preconfigured time gap.

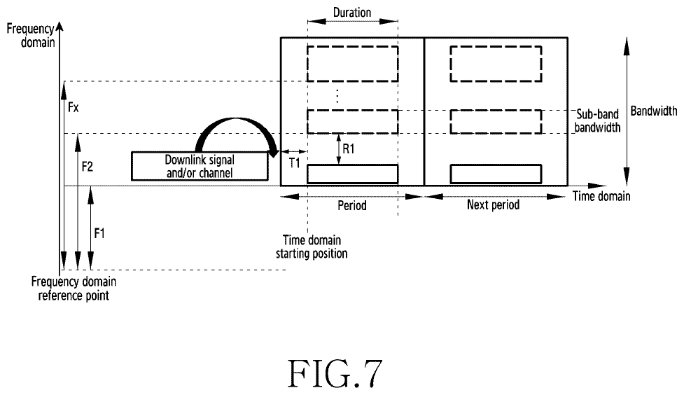

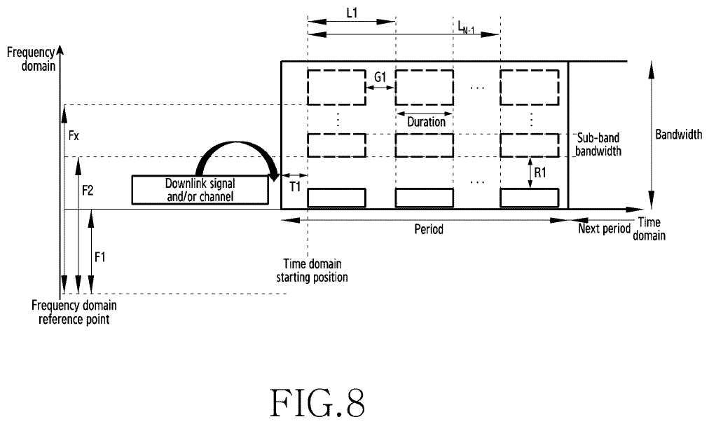

FIG. 7 illustrates an example for determining a group of periodic random access time domain resources based on a downlink signal and/or downlink channel according to an embodiment of the present disclosure, and FIG. 8 illustrates an example for determining multiple groups of periodic random access time domain resources based on a downlink signal and/or downlink channel according to an embodiment of the present disclosure.

In another optional implementation, the first offset is a time domain offset between the time domain reference point and the period starting position related to random access or synchronization. The configuration information further includes a third offset, wherein the third offset is a time domain offset between the period starting position related to random access or synchronization and the time domain starting or ending position of a resource related to random access. That is, the terminal may determine a group of periodic time domain resources used for random access by using the time domain reference point of the random access resource and the time domain resource period used for random access indicated based on the downlink signal and/or downlink channel, wherein, in a time domain resource period used for random access, the terminal device determines the time domain starting position of a time domain resource used for random access based on the time domain starting position of the time domain resource period used for random access and a predefined or preconfigured time domain offset T1 (third offset), or the time domain starting position of a time domain resource used for random access is not earlier than the time domain starting position of the time domain resource period used for random access plus a predefined or preconfigured time gap. The duration of a time domain resource used for random access is determined by receiving the downlink signal and/or downlink channel, as shown in FIG. 7. The time gap T1 is the time gap from the time domain starting position of the time domain resource period used for random access to the time domain starting position of the time domain resource used for random access. The content on the frequency domain in FIG. 7 can refer to the following description.

Optionally, the configuration information further includes a fourth offset, wherein the fourth offset is the time domain offset between the time domain starting position of the j^{th} resource related to random access and the time domain starting position of the first resource related to random access or the period starting position in a same period in a same period, where the first resource related to random access is a resource related to random access determined based on the third offset and the time domain starting position of the period, and the j is an integer greater than 1. That is, the terminal may determine a group of periodic time domain resources used for random access by using the time domain reference point of the random access resource and the time domain resource period used for random access indicated based on the downlink signal and/or downlink channel, wherein, in a time domain resource period used for random access, the terminal device determines the time domain starting positions of a group of N time domain resources used for random access based on the time domain starting position of the time domain resource period used for random access and a group of N predefined or preconfigured time domain offsets {T1, T1+L1, . . . , T1+L_{N-1}} (fourth offsets). The time domain offsets {T1,T1+L1, . . . , T1+L_{N-1}} are time gaps from the time domain starting position of the time domain resource period used for random access to the time domain starting positions of the time domain resources used for random access. Or the time domain starting positions of a group of N time domain resources used for random access are not earlier than the time domain starting position of the time domain resource period used for random access plus a group of N predefined or preconfigured time gaps. The time gap and/or time domain offset can be used for the reception of the synchronization signal. The duration of a time domain resource used for random access is determined by receiving the downlink signal and/or downlink channel, as shown in FIG. 8. The time domain offset T1 is the time gap from the time domain starting position of the time domain resource period used for random access to the time domain starting position of the first time domain resource used for random access.

Or the fourth offset is a time gap between two adjacent resources related to random access in time domain in a same period, wherein the first resource related to random access is a resource related to random access determined based on the third offset and the time domain starting position of the period, and the j is an integer greater than 1. That is, the terminal may determine a group of periodic time domain resources used for random access by using the time domain reference point of the random access resource and the time domain resource period used for random access indicated based on the downlink signal and/or downlink channel, wherein, in a time domain resource period used for random access, the terminal device determines the time domain starting position of the first time domain resource used for random access based on the time domain starting position of the time domain resource period used for random access and the time domain offset T1 (third offset), or the time domain starting position of the first time domain resource used for random access is not earlier than the time domain starting position of the time domain resource period used for random access plus a predefined or preconfigured time gap. The terminal device may determine the time domain starting positions of a group of N−1 time domain resources used for random access based on the time domain starting position or time domain ending position of the first time domain resource used for random access and a group of N−1 predefined or preconfigured time domain offsets (fourth offsets); or, the terminal device may determine the time domain starting positions of a group of N−1 time domain resources used for random access based on the starting position or ending position of the first time domain resource used for random access and a predefined or preconfigured time gap G1 (fourth offset); or, the time domain starting positions of a group of N−1 time domain resources used for random access are not earlier than the time domain starting or ending position of the first time domain resource used for random access plus a group of N−1 predefined or preconfigured time gaps; or, the time domain starting positions of subsequent N−1 time domain resources used for random access are not earlier than the time domain starting position or ending position of the previous time domain resource used for random access plus a predefined or preconfigured time gap. The duration of a time domain resource used for random access is determined by receiving the downlink signal and/or downlink channel, as shown in FIG. 8. The content on the frequency domain in FIG. 8 can refer to the following description.

In the embodiment of the present disclosure, the time domain offset and/or time gap and/or duration may be determined by a multiple of the absolute time unit, e.g., a multiple of 1 ms, 1 s or the like, or may be determined by the number of relative time units. The time unit (also referred to as the time domain unit) may be: an orthogonal frequency division multiplexing (OFDM) symbol, an OFDM symbol group (consisting of a plurality of OFDM symbols), a slot, a slot group (consisting of a plurality of slots), a sub-frame, a sub-frame group (consisting of a plurality of sub-frames), a system frame, a system frame group (consisting of a plurality of system frames), the duration occupied by the symbol 0, the duration occupied by the symbol 1, and the duration occupied by symbols 0 and 1. The time unit may also be a combination of a plurality of granularities, for example, N1 slots plus N2 OFDM symbols.

Further, an embodiment of the present disclosure provides a method for determining frequency domain resources used for random access.

In the embodiment of the present disclosure, if the terminal device reports a UE capability of supporting frequency division multiplexing, the terminal device may be configured with X frequency domain resources in a same time unit to transmit a signal and/or channel related to random access.

In the embodiment of the present disclosure, the configuration information related to random access may include configuration information of frequency domain resources used for random access. Specifically, the configuration information of the frequency domain resources used for random access may include, but not limited to, a combination of one or more of the following:
(1) the bandwidth of the frequency domain resources used for random access, which is used to indicate the width of the frequency domain resources used by the terminal device for uplink transmission in the frequency domain;
(2) the sub-band bandwidth occupied by the frequency domain resources used for random access, which is used to indicate the width of frequency domain resources occupied from the frequency domain starting positions of frequency domain resources used for random access, where this configuration is suitable for frequency domain multiplexing of a plurality of frequency domain resources at the same moment;
(3) the number X of frequency domain resources related to random access, i.e., the number X of frequency domain resources which can be used for random access in a same time unit;
(4) the frequency domain offset of the frequency domain starting position or frequency domain ending position of the frequency domain resource used for random access relative to the frequency domain reference point used for the random access resource; and/or
(5) the frequency domain gap between two adjacent frequency domain resources used for random access in frequency domain.

Wherein, the frequency domain gap between two adjacent frequency domain resources used for random access in frequency domain is the time gap from the frequency domain starting position or frequency domain ending position of the previous frequency domain resource used for random access to the frequency domain starting position of the next frequency domain resource used for random access, and may be a predefined or preconfigured real number or may be X−1 predefined values. This configuration is suitable for configuring a group of X frequency domain resources, and the X is a real number greater than 1.

Wherein, the frequency domain starting position may also be referred to as the frequency starting position or the frequency domain starting point position or the frequency domain starting point or the starting point; and correspondingly, the frequency domain ending position may also be referred to as the frequency ending position or the frequency domain ending point position or the frequency domain ending point.

In the embodiment of the present disclosure, the resources related to random access are also determined based on the frequency domain reference point related to random access, wherein the frequency domain reference point is a frequency domain starting position corresponding to an absolute radio-frequency channel number (ARFCN).

Optionally, the frequency domain reference point used for the random access resource includes at least one of the following:
(1) an absolute frequency point PointA;
(2) a frequency domain starting position of a physical resource block 0 (PRB0) of an uplink activation bandwidth part (BWP);
(3) the frequency domain ending position of the 10^{th} PRB of a synchronization signal block (SSB);
(4) indicated ARFCN;
(5) an uplink frequency domain starting position of a channel grid operating

band;
(6) a center frequency domain position of a channel grid operating band, the center frequency domain position of the channel grid operating band meaning the average value of the frequency domain starting position of the channel grid and the frequency ending position of the channel grid;
(7) a starting position of a channel grid operating band determined according to the channel grid operating band where the downlink signal and/or downlink channel is located;
(8) the indicated frequency domain starting position of a global synchronization channel number (GSCN);
(9) an uplink frequency domain reference point determined according to the frequency domain starting position of the downlink signal and/or downlink channel and a predefined or preconfigured frequency domain offset (fifth offset), which is particularly suitable for the determination of the frequency domain reference point of the uplink band in the FDD band;
(10) an uplink frequency domain reference point determined according to the frequency domain ending position of the downlink signal and/or downlink channel and the frequency domain offset (fifth offset), which is also suitable for the determination of the frequency domain reference point of the uplink band in the FDD band; and/or
(11) the frequency domain starting position used for uplink carrier transmission, e.g., the frequency domain starting position where the uplink carrier used for reflection is located.

In the embodiment of the present disclosure, the configuration information further includes a fifth offset, wherein the fifth offset is a frequency domain offset between the frequency domain reference point and the frequency domain starting or ending position of a resource related to random access. That is, the terminal device may determine the frequency domain starting position of a frequency domain resource used for random access according to the frequency domain reference point used for the random access resource and a predefined or preconfigured frequency domain offset (fifth offset), and determine a frequency domain resource used for random access based on the frequency domain starting position and the bandwidth of the frequency domain resource used for random access.

In an optional implementation, the terminal device may determine the frequency domain starting positions of a group of X frequency domain resources used for random access according to the frequency domain reference point used for the random access resource and a group of X predefined or preconfigured frequency domain offsets {F1, . . . ,F_{X}}, and determine a group of X frequency domain resources used for random access based on the frequency domain starting position and the bandwidth of the frequency domain resource used for random access. Wherein, the frequency domain offset is a frequency domain gap from the frequency domain reference point used for the random access resource to the frequency domain starting position of the frequency domain resource used for random access.

In another optional implementation, the configuration information further includes a sixth offset, wherein the sixth offset is the frequency domain offset between the frequency domain starting position of the kth resource related to random access and the frequency domain starting position of the first resource related to random access, wherein the first resource related to random access is a resource related to random access determined based on the fifth offset and the frequency domain reference point, and the k is an integer greater than 1. That is, the terminal device may determine the frequency domain starting position of the first frequency domain resource used for random access according to the frequency domain reference point used for the random access resource and a predefined or preconfigured frequency domain offset (fifth offset), and determine the frequency domain starting positions of subsequent X−1 frequency domain resources used for random access based on the frequency domain starting or ending position of the first frequency domain resource used for random access and X−1 predefined or preconfigured frequency domain offsets {F2, . . . ,FX}. Wherein, the frequency domain offset is a frequency domain gap from the frequency domain starting position of the first resource related to random access to the frequency domain starting position of each subsequent frequency domain resource used for random access.

Or the sixth offset is a frequency domain gap between two adjacent resources related to random access in frequency domain, wherein the first resource related to random access is a resource related to random access determined based on the fifth offset and the frequency domain reference point, and the k is an integer greater than 1. That is, the terminal device may determine the frequency domain starting position of the first frequency domain resource used for random access according to the frequency domain reference point used for the random access resource and a predefined or preconfigured frequency domain offset (fifth offset), and determine the frequency domain starting positions of subsequent X−1 frequency domain resources used for random access based on the frequency starting or ending position of the first frequency domain resource used for random access and the frequency domain gap R1 (sixth offset) between two adjacent frequency domain resources used for random access in frequency domain. Wherein, R1 is a predefined or preconfigured value, and is a real number greater than 0.

In the embodiment of the present disclosure, the frequency domain offset and/or bandwidth and/or frequency domain gap may be determined by a multiple of the absolute frequency unit, e.g., a multiple of 1 Hz, 1 KHz or the like, or may be determined by the number of relative frequency units. The frequency unit (also referred to as the frequency domain unit) may be: a subcarrier, a subcarrier group (consisting of a plurality of subcarriers), a resource block (RB) (also referred to as a physical resource block (PRB)), a resource block group (consisting of a plurality of RBs), a bandwidth part (BWP), a bandwidth part group (consisting of a plurality of BWPs), a band/carrier, a band group/carrier group, and a bandwidth of a single carrier signal. The frequency domain unit may also be a combination of a plurality of granularities, for example, M1 PRBs plus M2 subcarriers.

Further, an embodiment of the present disclosure further provides a method for determining a sequence used for random access.

In the embodiment of the present disclosure, the configuration information related to random access may include configuration information of the sequence used for random access. The configuration information may further include, but not limited to, at least one of the following:
(1) The total number of sequences related to random access. The terminal device randomly selects a sequence index at an equal probability based on the total number of configured sequences, and uses the sequence corresponding to the selected sequence index as the sequence used for random access;
(2) The length of sequences related to random access. The terminal device randomly generates a sequence with a fixed length of 0 to 1 bit based on the length of sequences related to random and uses the sequence as a sequence used for random access; and/or
(3) The indexes of sequences related to random access.

In the embodiment of the present disclosure, a sequence with the sequence length related to random access may be generated based on an international mobile subscriber identity (IMSI) of the terminal device, that is, a sequence with a fixed length used for random can may be uniquely generated. Optionally, the sequence used for random access may be the truncated IMSI. The length of the sequence used for random is predefined or preconfigured.

Further, an embodiment of the present disclosure further provides a resource configuration used for random access in a non-competitive random access process.

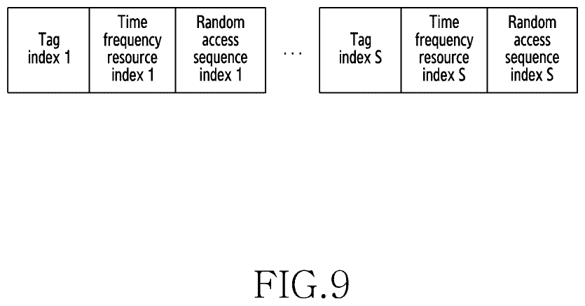

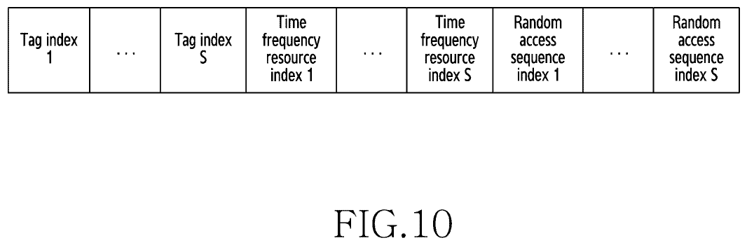

FIG. 9 illustrates information of a known terminal device according to an embodiment of the present disclosure, and FIG. 10 illustrates information of another known terminal device according to an embodiment of the present disclosure.

In the embodiment of the present disclosure, the configuration information further includes information of a known terminal device, wherein the information of the known terminal device includes at least one of the following: a terminal device index; indexes of the resources; and a sequence index.

Optionally, when the downlink signal and/or downlink channel indicates that one or a group of terminal devices with the known terminal device index execute a non-competitive random access process, the configuration information of the resources used for random access includes at least one of the following:
(1) A terminal device index and/or the index of a time frequency resource used for random access and/or the index of a sequence used for random access, which is used for the transmission of the non-competitive random access sequence. The terminal device transmits the indicated sequence used for random access on the time frequency resource corresponding to the index of the time frequency resource used for random access, and then initiates a random access process;
(2) The configuration information of a group of S resources used for random access. In the configuration information of S resources used for random access, the configuration information of a resource used for random access may include a terminal device index and/or the index of a time frequency resource used for random access and/or the index of a sequence used for random access, as shown in FIG. 9; and/or
(3) A group of S terminal device indexes and/or the indexes of S time frequency resources used for random access and/or the indexes of S sequences used for random access, as shown in FIG. 10.

In the embodiment of the present disclosure, the indexes of the resources are obtained by numbering the first time domain resources with regard to each frequency domain resource and numbering other time domain resources successively in the same manner. In other words, the correlation between time frequency resources used for random access and time frequency resource indexes may be that frequency domain resource numbering is performed, followed by time domain resource numbering. The first frequency domain resource is determined based on the frequency domain reference point and a predefined or preconfigured frequency offset (fifth offset), and the first time domain resource is determined based on the time domain reference point and a predefined or preconfigured time domain offset (first offset). That is, the index of the time frequency resource is 1. The second time frequency resource used for random access is determined according to the determined second frequency domain resource and the first time domain resource position, that is, the index of the time frequency resource is 2. Other resources are numbered in the same manner.

Wherein, the indexes of the resources are numbered by skipping the resource corresponding to the frequency domain position where the uplink carrier used for reflection is located. Specifically, if the terminal device reports a UE capability of supporting frequency division multiplexing, the terminal device does not select the time frequency resource corresponding to the frequency where the uplink carrier used for reflection is located as the time frequency resource used for random access. The correlation between time frequency resources used for random access and time frequency resource indexes may be that frequency domain resource numbering is performed first, followed by time domain resource numbering, and the time frequency resource corresponding to the frequency domain position where the uplink carrier used for reflection is skipped.

In the embodiment of the present disclosure, if the capability of the terminal device includes supporting frequency division multiplexing, the resources related to random access are mapped in an ascending order of the indexes of frequency domain resources of frequency division multiplexing and then mapped in an ascending order of the indexes of time domain resources. That is, the terminal device performs mapping in an ascending order of the indexes of frequency domain resources used for random access of frequency division multiplexing, and then performs mapping in an ascending order of the indexes of time domain resources used for random access. And/or, if the terminal device does not include the capability, the resources related to random access are mapped in an ascending order of the indexes of time domain resources. That is, if the terminal device does not support the UE capability of frequency division multiplexing, the terminal device performs mapping in an ascending order of the indexes of time domain resources used for random access.

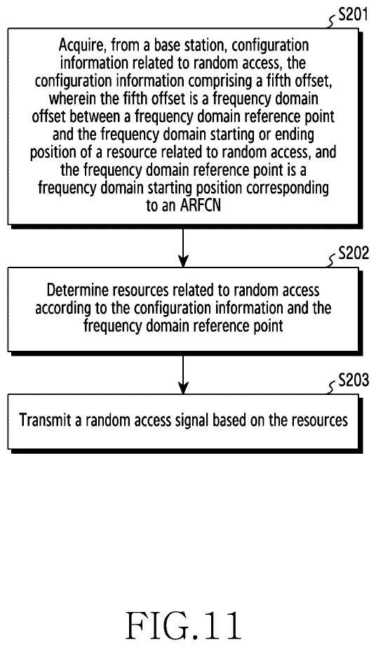

FIG. 11 illustrates another method executed by a terminal device in a communication system according to an embodiment of the present disclosure.

In an embodiment of the present disclosure, a method executed by a terminal device in a communication system is further provided. As shown in FIG. 11, this method includes:

In step S201, configuration information related to random access is acquired from a base station, the configuration information including a fifth offset, wherein the fifth offset is a frequency domain offset between a frequency domain reference point and the frequency domain starting or ending position of a resource related to random access, and the frequency domain reference point is a frequency domain starting position corresponding to an ARFCN.

In step S202, resources related to random access are determined according to the configuration information and the frequency domain reference point.

In step S203, a random access signal is transmitted based on the resources.

In an optional implementation, the frequency domain reference point further includes at least one of the following: an absolute frequency point; a frequency domain starting position of a PRB0 of an uplink activation BWP; a frequency domain ending position of the 10^{th} PRB of an SSB; an uplink frequency domain starting position of a channel grid operating band; a center frequency domain position of a channel grid operating band; a starting position of a channel grid operating band determined according to the channel grid operating band where the downlink signal and/or downlink channel is located; a frequency domain starting position of a GSCN; an uplink frequency domain reference point determined according to the frequency domain starting position of the downlink signal and/or downlink channel and the frequency domain offset; an uplink frequency domain reference point determined according to the frequency domain ending position of the downlink signal and/or downlink channel and the frequency domain offset; and, a frequency domain starting position used for uplink carrier transmission.

In an optional implementation, the fifth offset is a frequency domain offset between the frequency domain reference point and the time domain starting or ending position of a resource related to random access.

In an optional implementation, the configuration information further includes a sixth offset, wherein,
the sixth offset is a frequency domain gap between two adjacent resources related to random access in frequency domain; or,
the sixth offset is a frequency domain offset between the frequency domain starting position of the k^{th} resource related to random access and the frequency domain starting position of the first resource related to random access;
wherein the first resource related to random access is a resource related to random access determined based on the fifth offset and the frequency domain reference point, and the k is an integer greater than 1.

In an optional implementation, the configuration information further includes: the number X of frequency domain resources related to random access.

In an optional implementation, the configuration information further includes at least one of the following: the total number of sequences related to random access; the length of sequences related to random access; and the indexes of sequences related to random access.

In an optional implementation, this method further includes: generating a sequence with the sequence length related to random access based on an international mobile subscriber identity (IMSI).

In an optional implementation, the configuration information further includes information of a known terminal device, wherein the information of the known terminal device includes at least one of the following: a terminal device index; indexes of the resources; and a sequence index.

In an optional implementation, the indexes of the resources are obtained by numbering the first time domain resource with regard to each frequency domain resource and numbering other time domain resources successively in the same manner, wherein the indexes of the resources are numbered by skipping the resource corresponding to the frequency domain position where an uplink carrier used for reflection is located.

In an optional implementation, if the capability of the terminal device includes supporting frequency division multiplexing, the resources related to random access are mapped in an ascending order of the indexes of frequency domain resources of frequency division multiplexing and then mapped in an ascending order of the indexes of time domain resources;
and/or, if the terminal device does not include the capability, the resources related to random access are mapped in an ascending order of the indexes of time domain resources.

The detailed functional description of the method executed by a terminal device in a communication system provided in the embodiment of the present disclosure can specifically refer to the above corresponding description and will not be repeated here.

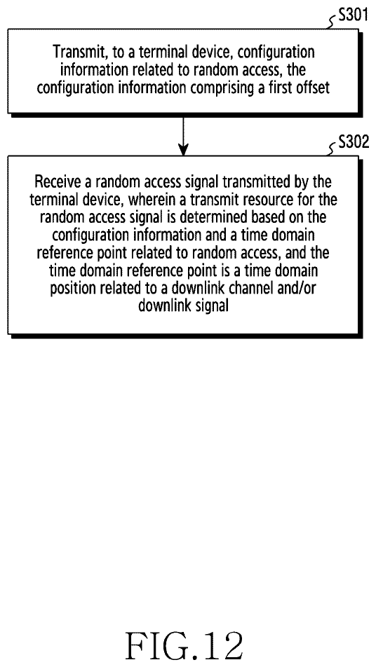

FIG. 12 illustrates a method executed by a base station in a communication system according to an embodiment of the present disclosure.

In an embodiment of the present disclosure, a method executed by a base station in a communication system is further provided. As shown in FIG. 12, the method includes the following steps.

In step S301, configuration information related to random access is transmitted to a terminal device, the configuration information including a first offset.

In step S301, a random access signal transmitted by the terminal device is received, wherein a transmit resource for the random access signal is determined based on the configuration information and a time domain reference point related to random access, and the time domain reference point is a time domain position related to a downlink channel and/or downlink signal.

In an optional implementation, the time domain reference point includes at least one of the following: a time domain starting position of a synchronization signal; a time domain ending position of the synchronization signal; a time domain starting position of a downlink signal and/or downlink channel carrying the configuration information; and a time domain ending position of the downlink signal and/or downlink channel carrying the configuration information.

In an optional implementation, the first offset is a time domain offset between the time domain reference point and the time domain starting or ending position of a resource related to random access.

In an optional implementation, the configuration information further includes a second offset, wherein the second offset is a time gap between two adjacent resources related to random access in time domain; or, the second offset is a time domain offset between the time domain starting position of the i^{th} resource related to random access and the time domain starting position of the first resource related to random access, wherein the first resource related to random access is a resource related to random access determined based on the first offset and the time domain reference point, and the i is an integer greater than 1.

In an optional implementation, the configuration information further includes: the number M of time domain resources related to random access.

In an optional implementation, the configuration information further includes a third offset, wherein the third offset is a time domain offset between a period starting position related to random access or synchronization and the time domain starting or ending position of a resource related to random access; and the first offset is a time domain offset between the time domain reference point and the period starting position related to random access or synchronization.

In an optional implementation, the configuration information further includes a fourth offset, wherein the fourth offset is a time gap between two adjacent resources related to random access in time domain in a same period; or, the fourth offset is a time domain offset between the time domain starting position of the j^{th} resource related to random access in a same period and the time domain starting position of the first resource related to random access or the period starting position of the period in a same period, wherein the first resource related to random access is a resource related to random access determined based on the third offset and the time domain starting position of the period, and the j is an integer greater than 1.

In an optional implementation, the configuration information further includes: the number N of time domain resources related to random access in a same period.

In an optional implementation, the resources related to random access are also determined based on a frequency domain reference point related to random access, wherein the frequency domain reference point is a frequency domain starting position corresponding to an ARFCN.

In an optional implementation, the frequency domain reference point further includes at least one of the following: an absolute frequency point; a frequency domain starting position of a PRB0 of an uplink activation BWP; the frequency domain ending position of the 10^{th} PRB of an SSB; an uplink frequency domain starting position of a channel grid operating band; a center frequency domain position of a channel grid operating band; a starting position of a channel grid operating band determined according to the channel grid operating band where the downlink signal and/or downlink channel is located; a frequency domain starting position of a GSCN; an uplink frequency domain reference point determined according to the frequency domain starting position of the downlink signal and/or downlink channel and the frequency domain offset; an uplink frequency domain reference point determined according to the frequency domain ending position of the downlink signal and/or downlink channel and the frequency domain offset; and, a frequency domain starting position used for uplink carrier transmission.

In an optional implementation, the configuration information further includes a fifth offset, wherein the fifth offset is a frequency domain offset between the frequency domain reference point and the frequency domain starting or ending position of a resource related to random access.

In an optional implementation, the configuration information further includes a sixth offset, wherein the sixth offset is a frequency domain gap between two adjacent resources related to random access in frequency domain; or, the sixth offset is a frequency domain offset between the frequency domain starting position of the k^{th} resource related to random access and the frequency domain starting position of the first resource related to random access, wherein the first resource related to random access is a resource related to random access determined based on the fifth offset and the frequency domain reference point, and the k is an integer greater than 1.

In an optional implementation, the configuration information further includes: the number X of frequency domain resources related to random access.

In an optional implementation, the configuration information further includes at least one of the following: the total number of sequences related to random access; the length of sequences related to random access; and the indexes of sequences related to random access.

In an optional implementation, a sequence with the sequence length related to random access is generated by the terminal device based on an international mobile subscriber identity (IMSI).

In an optional implementation, the configuration information further includes information of a known terminal device, wherein the information of the known terminal device includes at least one of the following: a terminal device index; indexes of the resources; and a sequence index.

In an optional implementation, the indexes of the resources are obtained by numbering the first time domain resource with regard to each frequency domain resource and numbering other time domain resources successively in the same manner, wherein the indexes of the resources are numbered by skipping the resource corresponding to the frequency domain position where an uplink carrier used for reflection is located.

In an optional implementation, if the capability of the terminal device includes supporting frequency division multiplexing, the resources related to random access are mapped in an ascending order of the indexes of frequency domain resources of frequency division multiplexing and then mapped in an ascending order of the indexes of time domain resources; and/or, if the terminal device does not include the capability, the resources related to random access are mapped in an ascending order of the indexes of time domain resources.

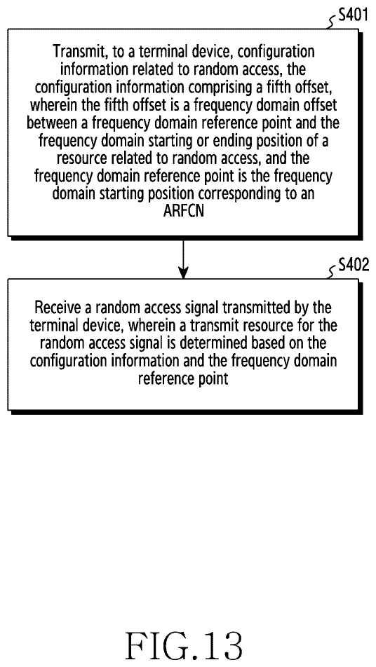

FIG. 13 illustrates another method executed by a base station in a communication system according to an embodiment of the present disclosure.

In an embodiment of the present disclosure, a method executed by a base station in a communication system is further provided. As shown in FIG. 13, the method includes the following steps.

In step S401, configuration information related to random access is transmitted to a terminal device, the configuration information including a fifth offset, wherein the fifth offset is a frequency domain offset between a frequency domain reference point and the frequency domain starting or ending position of a resource related to random access, and the frequency domain reference point is a frequency domain starting position corresponding to an ARFCN.

In step S402, a random access signal transmitted by the terminal device is received, wherein a transmit resource for the random access signal is determined based on the configuration information and the frequency domain reference point.

In an optional implementation, the frequency domain reference point further includes at least one of the following: an absolute frequency point; a frequency domain starting position of a PRB0 of an uplink activation BWP; the frequency domain ending position of the 10^{th} PRB of an SSB; an uplink frequency domain starting position of a channel grid operating band; a center frequency domain position of a channel grid operating band; a starting position of a channel grid operating band determined according to the channel grid operating band where the downlink signal and/or downlink channel is located; a frequency domain starting position of a GSCN; an uplink frequency domain reference point determined according to the frequency domain starting position of the downlink signal and/or downlink channel and the frequency domain offset; an uplink frequency domain reference point determined according to the frequency domain ending position of the downlink signal and/or downlink channel and the frequency domain offset; and, a frequency domain starting position used for uplink carrier transmission.

In an optional implementation, the fifth offset is a frequency domain offset between the frequency domain reference point and the time domain starting or ending position of a resource related to random access.

In an optional implementation, the configuration information further includes a sixth offset, wherein the sixth offset is a frequency domain gap between two adjacent resources related to random access in frequency domain; or, the sixth offset is a frequency domain offset between the frequency domain starting position of the k^{th} resource related to random access and the frequency domain starting position of the first resource related to random access, wherein the first resource related to random access is a resource related to random access determined based on the fifth offset and the frequency domain reference point, and the k is an integer greater than 1.

In an optional implementation, the configuration information further includes: the number X of frequency domain resources related to random access.

In an optional implementation, the configuration information further includes at least one of the following: the total number of sequences related to random access; the length of sequences related to random access; and the indexes of sequences related to random access.

In an optional implementation, a sequence with the sequence length related to random access is generated by the terminal device based on an international mobile subscriber identity (IMSI).

In an optional implementation, the configuration information further includes information of a known terminal device, wherein the information of the known terminal device includes at least one of the following: a terminal device index; indexes of the resources; and a sequence index.

In an optional implementation, the indexes of the resources are obtained by numbering the first time domain resource with regard to each frequency domain resource and numbering other time domain resources successively in the same manner, wherein the indexes of the resources are numbered by skipping the resource corresponding to the frequency domain position where an uplink carrier used for reflection is located.

In an optional implementation, if the capability of the terminal device includes supporting frequency division multiplexing, the resources related to random access are mapped in an ascending order of the indexes of frequency domain resources of frequency division multiplexing and then mapped in an ascending order of the indexes of time domain resources; and/or, if the terminal device does not include the capability, the resources related to random access are mapped in an ascending order of the indexes of time domain resources.

The method executed by a base station in a communication system provided in the embodiment of the present disclosure has an implementation principle corresponding to that of the terminal device side and has the corresponding technical effects, and the detailed functional description of the base station side can specifically refer to the above description of the corresponding method of the terminal device side and will not be repeated here.

An embodiment of the present disclosure provides an electronic device, including: a transceiver, which is configured to transmit and receive signals; and, a processor, which is coupled to the transceiver and configured to implement the steps in the above method embodiments. Optionally, if the electronic device may be a terminal device, the processor is configured to implement the steps in the embodiments of the method executed by a terminal device. The detailed functional description and the achieved beneficial effects can specifically refer to the above description of the embodiments of the method executed by a terminal device and will not be repeated here. Optionally, if the electronic device may be a UE, the processor is configured to implement the steps in the embodiments of the method executed by a base station. The detailed functional description and the achieved beneficial effects can specifically refer to the above description of the embodiments of the method executed by a base station and will not be repeated here. In practical applications, the terminal device or the base station can be construed as different network nodes.

An embodiment of the present disclosure further provides an electronic device, including a processor, and optionally a transceiver and/or memory coupled to the processor, wherein the processor is configured to execute the steps of the method provided in any one of the optional embodiments of the present disclosure.

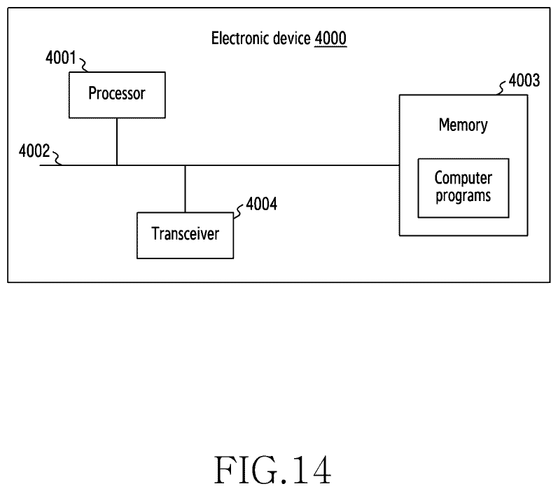

FIG. 14 illustrates an electronic device according to an embodiment of the present disclosure.

FIG. 14 shows a schematic structure diagram of an electronic device to which an embodiment of the present disclosure is applied. As shown in FIG. 14, the electronic device 4000 in FIG. 14 includes a processor 4001 and a memory 4003. The processor 4001 is connected to the memory 4003, for example, via a bus 4002. Optionally, the electronic device 4000 may further include a transceiver 4004. The transceiver 4004 may be configured for data interaction between this electronic device and other electronic devices, for example, transmitting data and/or receiving data. It is to be noted that, in practical applications, the number of the transceiver 4004 is not limited to 1, and the structure of the electronic device 4000 does not constitute any limitations to the embodiments of the present disclosure. Optionally, the electronic device may be a first network node, a second network node or a third network node.

The processor 4001 may be a central processing unit (CPU), a general-purpose processor, a digital signal processor (DSP), an application specific integrated circuit (ASIC), a field programmable gate array (FPGA) or other programmable logic devices, transistor logic devices, hardware components or any combination thereof. The processor can implement or execute various exemplary logic blocks, modules and circuits described in the content disclosed by the present disclosure. The processor 4001 may also be a combination for realizing computing functions, for example, a combination of one or more microprocessors, a combination of DSPs and microprocessors, etc.

The bus 4002 may include a passageway for transferring information between the above components. The bus 4002 may be a peripheral component interconnect (PCI) bus, an extended industry standard architecture (EISA) bus, etc. The bus 4002 may be classified into address bus, data bus, control bus, etc. For ease of representation, the bus is represented by only one bold line in FIG. 14, but it does not mean that there is only one bus or one type of buses.

The memory 4003 may be, but not limited to, read only memories (ROMs) or other types of static storage devices capable of storing static information and instructions, random access memories (RAMs) or other types of dynamic storage devices capable of storing information and instructions, or electrically erasable programmable read only memories (EEPROMs), compact disc read only memories (CD-ROMs) or other optical disc storages, optical disc storages (including compact discs, laser discs, optical discs, digital versatile optical discs, Blue-ray discs, etc.), magnetic disc storage mediums or other magnetic storage devices, or any other medium that can be used to carry or store computer programs and can be accessed by a computer.

The memory 4003 is configured to store computer programs for executing the embodiments of the present disclosure, and is controlled and executed by the processor 4001. The processor 4001 is configured to execute the computer programs stored in the memory 4003 to implement the steps in the above method embodiments.

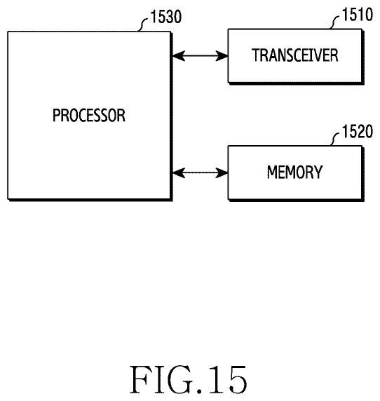

FIG. 15 illustrates a structure of a UE according to an embodiment of the present disclosure.

As shown in FIG. 15, the UE according to an embodiment may include a transceiver 1510, a memory 1520, and a processor 1530. The transceiver 1510, the memory 1520, and the processor 1530 of the UE may operate according to a communication method of the UE described above. However, the components of the UE are not limited thereto. For example, the UE may include more or fewer components than those described above. In addition, the processor 1530, the transceiver 1510, and the memory 1520 may be implemented as a single chip. Also, the processor 1530 may include at least one processor.

The transceiver 1510 collectively refers to a UE receiver and a UE transmitter, and may transmit/receive a signal to/from a base station. The signal transmitted or received to or from the base station may include control information and data. The transceiver 1510 may include a RF transmitter for up-converting and amplifying a frequency of a transmitted signal, and a RF receiver for amplifying low-noise and down-converting a frequency of a received signal. However, this is only an example of the transceiver 1510 and components of the transceiver 1510 are not limited to the RF transmitter and the RF receiver.

Also, the transceiver 1510 may receive and output, to the processor 1530, a signal through a wireless channel, and transmit a signal output from the processor 1530 through the wireless channel.

The memory 1520 may store a program and data required for operations of the UE. Also, the memory 1520 may store control information or data included in a signal obtained by the UE. The memory 1520 may be a storage medium, such as read-only memory (ROM), random access memory (RAM), a hard disk, a CD-ROM, and a DVD, or a combination of storage media.

The processor 1530 may control a series of processes such that the UE operates as described above. For example, the transceiver 1510 may receive a data signal including a control signal transmitted by the base station, and the processor 1530 may determine a result of receiving the control signal and the data signal transmitted by the base station.

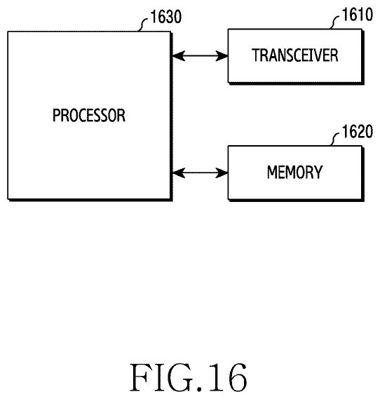

FIG. 16 illustrates a base station according to an embodiment of the present disclosure.

As shown in FIG. 16, the base station according to an embodiment may include a transceiver 1610, a memory 1620, and a processor 1630. The transceiver 1610, the memory 1620, and the processor 1630 of the base station may operate according to a communication method of the base station described above. However, the components of the base station are not limited thereto. For example, the base station may include more or fewer components than those described above. In addition, the processor 1630, the transceiver 1610, and the memory 1620 may be implemented as a single chip. Also, the processor 1630 may include at least one processor.

The transceiver 1610 collectively refers to a base station receiver and a base station transmitter, and may transmit/receive a signal to/from a terminal. The signal transmitted or received to or from the terminal may include control information and data. The transceiver 1610 may include a RF transmitter for up-converting and amplifying a frequency of a transmitted signal, and a RF receiver for amplifying low-noise and down-converting a frequency of a received signal. However, this is only an example of the transceiver 1610 and components of the transceiver 1610 are not limited to the RF transmitter and the RF receiver.

Also, the transceiver 1610 may receive and output, to the processor 1630, a signal through a wireless channel, and transmit a signal output from the processor 1630 through the wireless channel.

The memory 1620 may store a program and data required for operations of the base station. Also, the memory 1620 may store control information or data included in a signal obtained by the base station. The memory 1620 may be a storage medium, such as read-only memory (ROM), random access memory (RAM), a hard disk, a CD-ROM, and a DVD, or a combination of storage media.

The processor 1630 may control a series of processes such that the base station operates as described above. For example, the transceiver 1610 may receive a data signal including a control signal transmitted by the terminal, and the processor 1630 may determine a result of receiving the control signal and the data signal transmitted by the terminal.

An embodiment of the present disclosure provides a computer-readable storage medium having computer programs stored thereon that, when executed by a processor, can implement the steps and corresponding contents in the above method embodiments.

An embodiment of the present disclosure further provides a computer program product, including computer programs that, when executed by a processor, can implement the steps and corresponding contents in the above method embodiments.

The terms “first,” “second,” “third,” “fourth,” “1,” “2” and the like (if any) in the specification and claims of the present disclosure and the drawings are used for distinguishing similar objects, rather than describing a particular order or precedence. It should be understood that data, as used in such a way, can be used interchangeably if appropriate, so that the embodiments of the present disclosure described herein can be implemented in an order other than those illustrated or described here.

It should be understood that, although the operation steps are indicated by arrows in the flowcharts of the embodiments of the present disclosure, these steps are not necessarily implemented in the order indicated by the arrows. Unless explicitly stated herein, in some implementation scenarios of the embodiments of the present disclosure, the implementation steps in the flowcharts can be executed in other orders as required. In addition, based on actual implementation scenarios, some or all of the steps in the flowcharts can include multiple sub-steps or multiple stages. Some or all of the sub-steps or stages can be executed at the same moment, and each of the sub-steps or stages can be executed at a different moment. In scenarios with different execution moments, the execution order of these sub-steps or stages can be flexibly configured as required, which is not limited in the embodiments of the present disclosure.

The text and the drawings are merely provided as examples to help readers to understand the present disclosure. They are not intended to limit the scope of the present disclosure in any way. Although some embodiments and examples have been provided, based on the contents disclosed herein, it is obvious for those skilled in the art that the illustrated embodiments and examples can be altered without departing from the scope of the present disclosure, and other similar implementation means based on the technical idea of the present disclosure shall also fall into the protection scope of the embodiments of the present disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A terminal in a wireless communication system, the terminal comprising:
a transceiver; and
a controller coupled with the transceiver, and configured to:
receive, from a base station, a downlink signal, and
transmit, to the base station, an uplink signal after a time gap from the reception of the downlink signal,
wherein the time gap is determined based on the downlink signal, and
wherein the terminal is an ambient-internet of things (A-IoT) device.

2. The terminal of claim 1, wherein the downlink signal is associated with a random access,
wherein the uplink signal is transmitted on a plurality of time domain resources for the random access, and
wherein a number of the plurality of time domain resources is determined based on the downlink signal.

3. The terminal of claim 1, wherein the downlink signal includes information configuring a frequency domain resource for a random access.

4. The terminal of claim 1, wherein the downlink signal is for one or more terminals including the terminal, and
wherein the downlink signal includes at least one of an identifier of the terminal or an identifier of a group of terminals.

5. A base station in a wireless communication system, the base station comprising:
a transceiver; and
a controller coupled with the transceiver, and configured to:
transmit, to a terminal, a downlink signal, and
receive, from the terminal, an uplink signal after a time gap from the transmission of the downlink signal,
wherein the time gap is based on the downlink signal, and
wherein the terminal is an ambient-internet of things (A-IoT) device.

6. The base station of claim 5, wherein the downlink signal is associated with a random access,
wherein the uplink signal is transmitted on a plurality of time domain resources for the random access, and
wherein a number of the plurality of time domain resources is based on the downlink signal.

7. The base station of claim 5, wherein the downlink signal includes information configuring a frequency domain resource for a random access.

8. The base station of claim 5, wherein the downlink signal is transmitted for one or more terminals including the terminal, and
wherein the downlink signal includes at least one of an identifier of the terminal or an identifier of a group of terminals.

9. A method performed by a terminal in a wireless communication system, the method comprising:
receiving, from a base station, a downlink signal; and
transmitting, to the base station, an uplink signal after a time gap from the reception of the downlink signal,
wherein the time gap is determined based on the downlink signal, and
wherein the terminal is an ambient-internet of things (A-IoT) device.

10. The method of claim 9, wherein the downlink signal is associated with a random access,
wherein the uplink signal is transmitted on a plurality of time domain resources for the random access, and
wherein a number of the plurality of time domain resources is determined based on the downlink signal.

11. The method of claim 9, wherein the downlink signal includes information configuring a frequency domain resource for a random access.

12. The method of claim 9, wherein the downlink signal is for one or more terminals including the terminal, and
wherein the downlink signal includes at least one of an identifier of the terminal or an identifier of a group of terminals.

13. A method performed by a base station in a wireless communication system, the method comprising:
transmitting, to a terminal, a downlink signal; and
receiving, from the terminal, an uplink signal after a time gap from the transmission of the downlink signal,
wherein the time gap is based on the downlink signal, and
wherein the terminal is an ambient-internet of things (A-IoT) device.

14. The method of claim 13, wherein the downlink signal is associated with a random access,
wherein the uplink signal is transmitted on a plurality of time domain resources for the random access, and
wherein a number of the plurality of time domain resources is based on the downlink signal.

15. The method of claim 13, wherein the downlink signal includes information configuring a frequency domain resource for a random access.

16. The method of claim 13, wherein the downlink signal is transmitted for one or more terminals including the terminal, and
wherein the downlink signal includes at least one of an identifier of the terminal or an identifier of a group of terminals.
